(19) United States
(12) Patent Application Publication
(10) Pub. No.: US 2007/0075932 A1
(43) Pub. Date: Apr. 5, 2007

(54) Plasma display device

(75) Inventors: Isao Furukawa, Tama (JP); Makoto Onozawa, Yokohama (JP)

Correspondence Address: MCDERMOTT WILL & EMERY LLP, 600 13TH STREET, N.W., WASHINGTON, DC, 20005-3096, US

(73) Assignee: FUJITSU HITACHI PLASMA DISPLAY LIMITED

(21) Appl. No.: 11/525,998

(22) Filed: Sep. 25, 2006

(30) Foreign Application Priority Data
Sep. 30, 2005 (JP) 2005-287264

(51) Int. Cl. G09G 3/28

(52) U.S. Cl. 345/67

(57) ABSTRACT

A plasma display device includes first and second substrates; a plurality of X-electrodes provided on the first substrate; a plurality of Y-electrodes provided on the first substrate so as to be disposed in parallel with the plurality of X-electrodes, for generating sustain discharge between the plurality of X-electrodes and the Y-electrodes; a plurality of address electrodes provided on the second substrate so as to intersect with the X-electrodes and the Y-electrodes, for generating address discharge between the Y-electrodes and the address electrodes; and a scanning circuit for successively applying scan pulses for address discharge to the plurality of Y-electrodes. The scanning circuit is constituted of first and second scanning ICs, and the first and second scanning ICs are mounted on both surfaces of a circuit substrate, respectively.

### CROSS-REFERENCE TO RELATED APPLICATIONS

This application is based upon and claims the benefit of priority from the prior Japanese Patent Application No. 2005-287264, filed on Sep. 30, 2005, the entire contents of which are incorporated herein by reference.

### BACKGROUND OF THE INVENTION

1. Field of the Invention

The present invention relates to a plasma display device.

2. Description of the Related Art

The plasma display device includes a scanning IC (integrated circuit) generating a scan pulse for selecting a pixel to be displayed. With the progress of high definition plasma display device, the development of an HDTV (high definition television) is being carried out. In the HDTV, the number of electrodes supplying scan pulses increases. Accompanying the above, the number of terminals on which the scanning IC outputs scan pulses is also increased.

### SUMMARY OF THE INVENTION

It is an object of the present invention to provide a plasma display device capable of handling high definition image display.

According to the present invention, the plasma display device includes first and second substrates; a plurality of X-electrodes provided on the first substrate; a plurality of Y-electrodes provided on the first substrate so as to be disposed in parallel with the plurality of X-electrodes, for generating sustain discharge between the plurality of X-electrodes and the Y-electrodes; a plurality of address electrodes provided on the second substrate so as to intersect with the X-electrodes and the Y-electrodes, for generating address discharge between the Y-electrodes and the address electrodes; an X-electrode drive circuit for applying voltage for the sustain discharge to the plurality of X-electrodes; a Y-electrode drive circuit for applying voltage for the sustain discharge to the plurality of Y-electrodes; an address electrode drive circuit for applying voltage for the address discharge to the plurality of address electrodes; and a scanning circuit for successively applying scan pulses for the address discharge to the plurality of Y-electrodes. In the above plasma display device, the scanning circuit is constituted of first and second scanning ICs (integrated circuit), and the first and second scanning ICs are mounted on both surfaces of a circuit substrate (which is formed using a rigid substrate or the like).

### BRIEF DESCRIPTION OF THE DRAWINGS

FIG. 1 shows a diagram illustrating an exemplary configuration of a plasma display device according to a first embodiment of the present invention.

FIG. 2 shows an exploded perspective view illustrating the exemplary configuration of the plasma display panel according to the first embodiment.

FIG. 3A shows a side view illustrating exemplary configurations of a rigid substrate having a single-sided mounting structure and a scanning IC.

FIG. 3B shows a plan view of the exemplary configuration shown in FIG. 3A.

FIG. 4A shows a side view illustrating an exemplary configuration of a rigid substrate having a double-sided mounting structure and a scanning IC according to the first embodiment.

FIG. 4B shows a plan view of the exemplary configuration shown in FIG. 4A.

FIG. 5 shows a circuit diagram illustrating exemplary configurations of the first and second scanning ICs.

FIG. 6 shows a diagram illustrating the waveforms of a voltage V1 of the output terminal of the first scanning IC and a voltage V2 of the output terminal of the second scanning IC.

FIG. 7 shows a circuit diagram illustrating the first and second scanning ICs having penetration current prevention circuits according to the first embodiment.

FIG. 8 shows plan views illustrating pin (terminal) layouts of the first and second scanning ICs.

FIG. 9 shows a cross-sectional view illustrating an exemplary configuration of the rigid substrate.

FIG. 10 shows a cross-sectional view illustrating an exemplary configuration of a rigid substrate according to a second embodiment of the present invention.

FIG. 11 shows the plan views of the first layer to the fourth layer of the rigid substrate according to the second embodiment.

FIG. 12 shows the plan views of the fifth layer to the eighth layer of the rigid substrate according to the second embodiment.

FIG. 13 shows the plan views of the first layer to the fourth layer of a rigid substrate according to a third embodiment of the present invention.

FIG. 14 shows the plan views of the fifth layer to the eighth layer of the rigid substrate according to the third embodiment.

FIG. 15 shows cross-sectional views illustrating exemplary configurations of the first and second scanning ICs shown in FIG. 8.

FIG. 16 shows a diagram illustrating an exemplary configuration of one frame of an image according to the first embodiment.

### DETAILED DESCRIPTION OF THE PREFERRED EMBODIMENTS

### First Embodiment

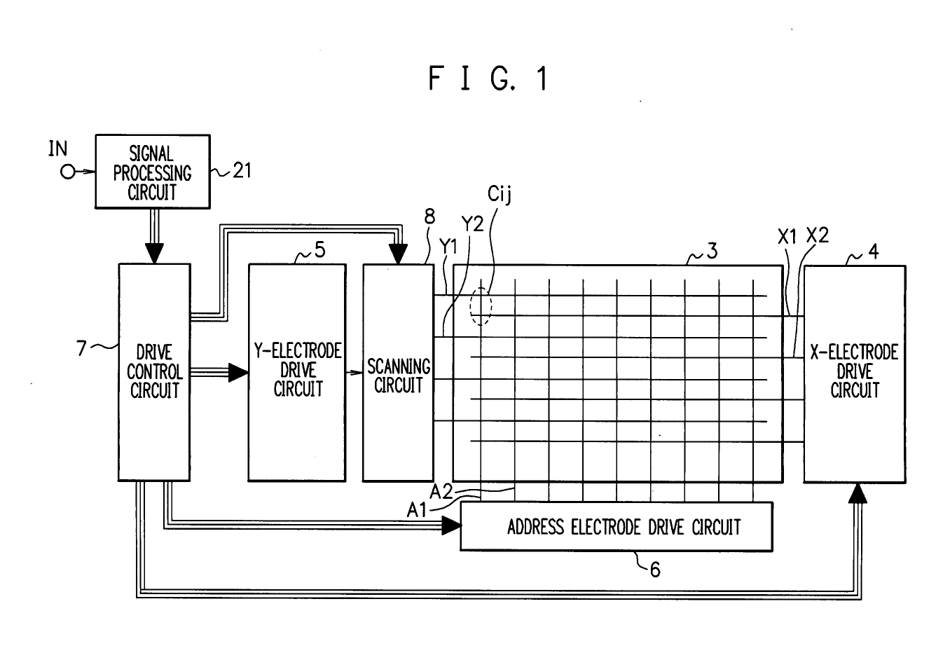

FIG. 1 shows a diagram illustrating an exemplary configuration of a plasma display device according to a first embodiment of the present invention. A signal processing circuit 21 processes a signal input from an input terminal IN, and outputs it to a drive control circuit 7. The drive control circuit 7 controls an X-electrode drive circuit 4, a Y-electrode drive circuit 5, a scanning circuit 8 and an address electrode drive circuit 6. The X-electrode drive circuit 4 supplies a predetermined voltage to a plurality of X-electrodes X1, X2, Hereinafter, each X-electrode X1, X2, . . . or the generic term thereof is referred to as X-electrode X1, where i signifies a suffix. The Y-electrode drive circuit 5 supplies a predetermined voltage to a plurality of Y-electrodes Y1, Y2, . . . , via the scanning circuit 8. Hereafter, each Y-electrode Y1, Y2, . . . or the generic term thereof is referred to as Y-electrode Yi, where i signifies a suffix. The address electrode drive circuit 6 supplies a predetermined voltage to a plurality of address electrodes A1, A2, . . . . Hereinafter, each address electrode A1, A2, . . . or the generic term thereof is referred to as address electrode Aj, where j signifies a suffix.

In the plasma display panel 3, the X-electrode Xi and the Y-electrode Yi form a row extending in parallel in the horizontal direction, while the address electrode Aj forms a column extending in the vertical direction so as to intersect with the X-electrode Xi and the Y-electrode Yi. The Y-electrode Yi and the X-electrode Xi are disposed alternately in the vertical direction. The Y-electrode Yi and the address electrode Aj form a two-dimensional matrix having i rows and j columns. A display cell Cij is formed of a cross point of a Y-electrode Yi and an address electrode Aj and an X-electrode Xi being disposed in an adjacent location correspondingly thereto. The above display cell Cij corresponds to a pixel, by which the plasma display panel 3 can display a two-dimensional image. An HDTV with a full specification has pixels of 1,920 (horizontal direction)×1,080 (vertical direction).

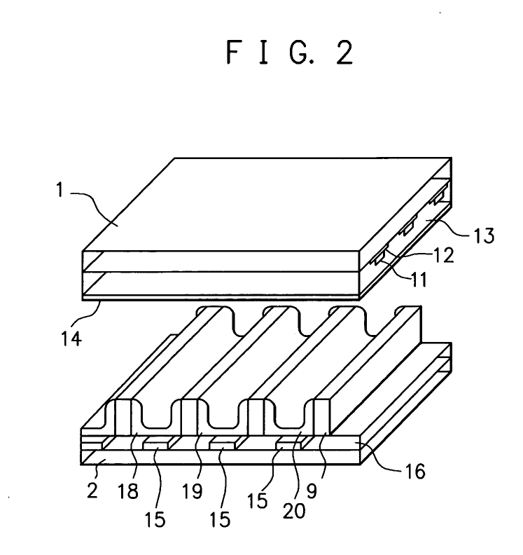

FIG. 2 shows an exploded perspective view illustrating an exemplary structure of a plasma display panel according to the present embodiment. A bus electrode 11 is formed on a transparent electrode 12. The pair of electrodes 11 and 12 corresponds to the X-electrode Xi or the Y-electrode Yi shown in FIG. 1. The X-electrode Xi and the Y-electrode Yi are formed alternately on a front surface glass substrate 1. On the top thereof, a dielectric layer 13 is deposited to cover for the purpose of insulation from a discharge space. Further, an MgO (magnesium oxide) protection layer 14 is deposited on the dielectric layer 13. Meanwhile, corresponding to the address electrode Aj shown in FIG. 1, the address electrode 15 is formed on a back surface glass substrate 2 which is disposed to face the front surface glass substrate 1. On the top thereof, a dielectric layer 16 is deposited. Further, on the top thereof, red phosphor layer 18, green phosphor layer 19 and blue phosphor layer 20 are deposited. On the internal surface of a partition wall (rib) 9, red, blue and green phosphor layers 18-20 are disposed and coated in a stripe shape on a color-by-color basis. Each color is emitted from the phosphor layers 18-20 which are excited by the discharge between the X-electrode Xi and the Y-electrode Yi. In the discharge space between the front surface glass substrate 1 and the back surface glass substrate 2, a discharge gas such as Ne+Xe Penning gas is sealed.

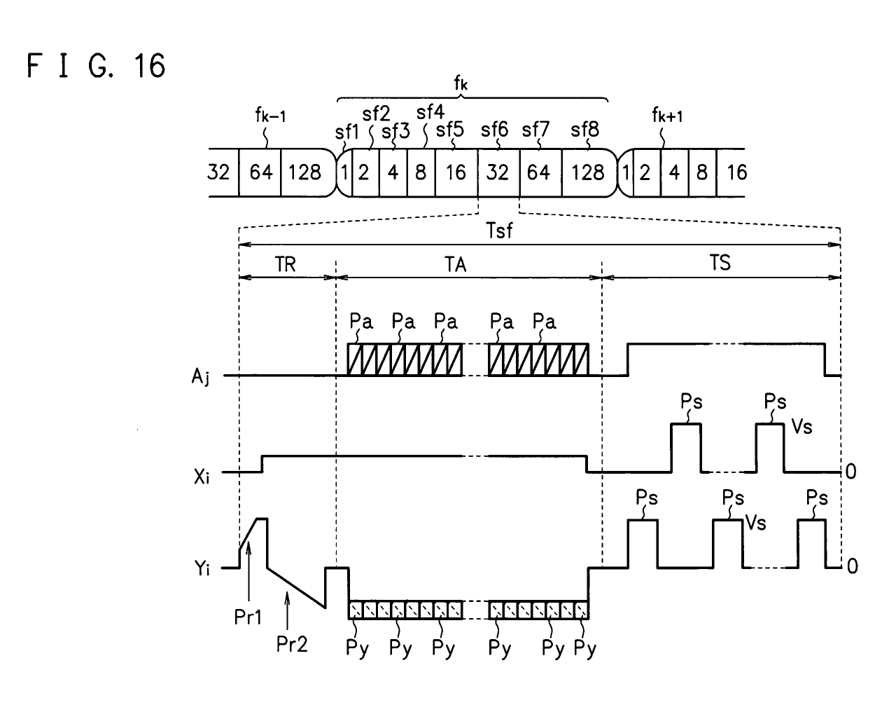

FIG. 16 shows a diagram illustrating an exemplary configuration of one frame fk of an image according to the present embodiment. The image is constituted of a plurality of frames fk−1, fk, fk+1, etc. One frame fk is formed of, for example, a first subframe sf1, a second subframe sf2, . . . to an eighth subframe sf8. Hereinafter, each subframe sf1, sf2, . . . or a generic term thereof is referred to as subframe sf. Each subframe sf includes a weight corresponding to the number of gradation bits.

Each subframe sf is constituted of a reset period TR, an address period TA and a sustain (hold) discharge period TS. In the reset period TR, each display cell Cij is initialized. To the Y-electrode Yi, a positive obtuse wave (a waveform having a positive gradient) Pr1 and a negative obtuse wave (a waveform having a negative gradient) Pr2 are applied.

In the address period TA, emission or non-emission of each display cell Cij can be selected by an address discharge between the address electrode Aj and the Y-electrode Yi. More specifically, scan pulses Py are successively applied to the Y-electrodes Y1, Y2, Y3, Y4, . . . . Then, by applying an address pulse Pa to the address electrode Aj corresponding to the above each scan pulse Py, emission or non-emission of a desired display cell Cij can be selected.

In the sustain period TS, a sustain discharge is performed between the X-electrode Xi and the Y-electrode Yi of the selected display cell Cij, and thereby emission is performed. In each subframe sf, the number of times of emission caused by sustain discharge pulses Ps between the X-electrode Xi and the Y-electrode Yi (namely, the length of the sustain period TS) differs. This can fix a gradation value. Each sustain discharge pulse Ps is a pulse having either 0 V or a voltage Vs.

The scanning circuit 8 shown in FIG. 1 successively applies the scan pulses Py to the plurality of Y-electrodes Yi for the purpose of the address discharge in the address period TA. Also, in the address period TA, the address electrode drive circuit 6 applies address pulses Pa to the plurality of address electrodes Aj for the address discharge. The X-electrode drive circuit 4 applies the sustain discharge pulses Ps to the plurality of X-electrodes Xi in the sustain period TS. The Y-electrode drive circuit 5 applies reset voltages Pr1, Pr2 to the plurality of Y-electrodes Yi in the reset period TR, and also applies the sustain discharge pulses Ps to the plurality of Y-electrodes Yi for the sustain discharge in the sustain period TS.

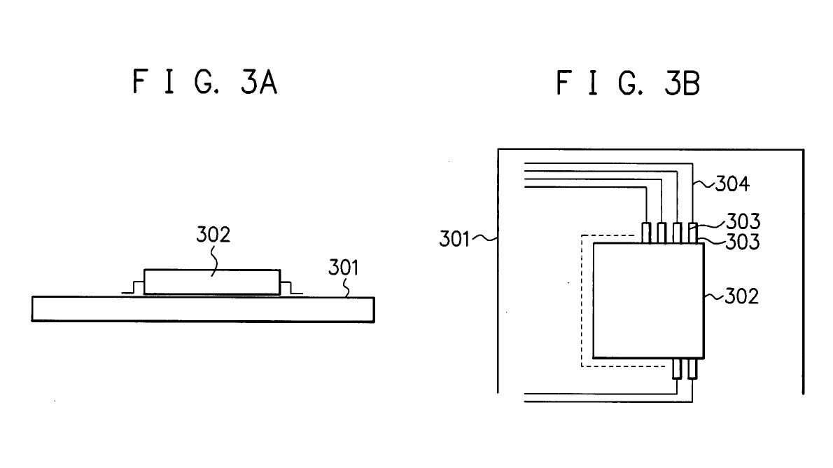

FIG. 3A shows a side view illustrating exemplary configurations of a rigid (hard) substrate 301 having a single-sided mounting structure and a scanning IC 302, and FIG. 3B shows the plan view thereof. On one surface of the rigid substrate (circuit substrate) 301, the scanning IC 302 is mounted. The scanning IC 302 corresponds to the scanning circuit 8 shown in FIG. 1. The scanning IC 302 includes a plurality of output terminals 303 for outputting a plurality of scan pulses. Each output line 304 is connected to adjacent two output terminals 303. The plurality of output lines 304 is respectively connected to the plurality of Y-electrodes Yi shown in FIG. 1.

When driving a large-sized display panel 3 of 55-inch type or the like, it is necessary to drive each Y-electrode Yi by means of two output terminals 303 of the scanning IC 302, from the matter of driving capability of the scanning IC 302. The above two output terminals 303 output scan pulses of identical shape. The scanning IC 302 is mounted on one surface of the rigid substrate 301. However, as high definition of the plasma display device becomes in progress, since the number of Y-electrodes Yi increases, it becomes necessary to increase the number of output terminals of the scanning IC 302. Therefore, according to the present embodiment, two scanning ICs are mounted on both surfaces of the rigid substrate.

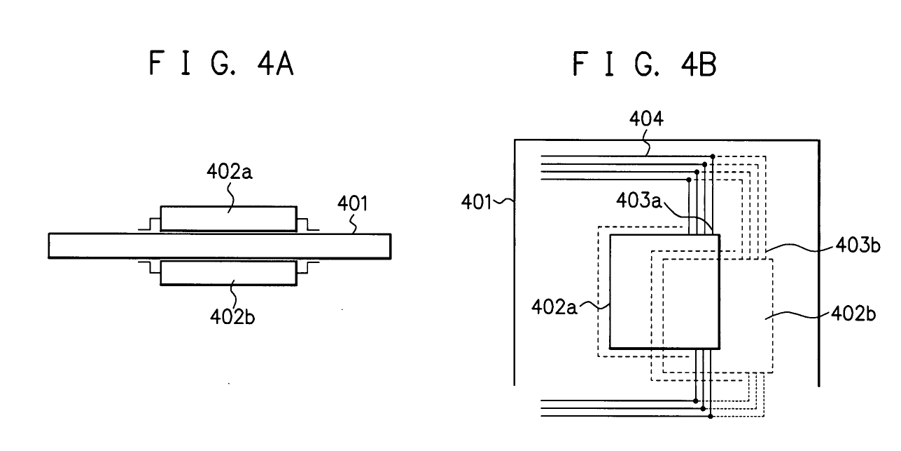

FIG. 4A shows a side view illustrating an exemplary configuration of the rigid substrate 401 of a double-sided mounting structure and having scanning ICs 402a, 402b according to the present embodiment, and FIG. 4B shows the plan view thereof. Scanning ICs 402a, 402b are mounted respectively on both surfaces of the rigid substrate 401. A first scanning IC 402a is mounted on the front surface of the rigid substrate 401, while a second scanning IC 402b is mounted on the back surface of the rigid substrate 401. The scanning ICs 402a, 402b correspond to the scanning circuit 8 shown in FIG. 1. The scanning IC 402a includes a plurality of output terminals 403a for outputting a plurality of scan pulses. The scanning IC 402b includes a plurality of output terminals 403b for outputting a plurality of scan pulses. The corresponding one output terminal 403a and one output terminal 403b form one set, which are short-circuited. Each output line 404 is connected to one output terminal 403a of the scanning IC 402a and one output terminal 403b of the scanning IC 402b via the rigid substrate 401. The two output terminals 403a, 403b connected together output scan pulses of identical shape. This can increase the drive capability of the scanning ICs 402a, 402b, as described above. The plurality of output lines 404 is respectively connected to the plurality of Y-electrodes Yi shown in FIG. 1.

By the use of the two scanning ICs 402a, 402b, the number of output terminals 403a, 403b of the scan pulses can be increased. This can realize a high definition plasma display device having a number of Y-electrodes Yi. An HDTV includes pixels of 1,920 (horizontal direction)×1.080 (vertical direction). By mounting two scanning ICs 402a, 402b on both surfaces of the rigid substrate 401, it is possible to employ the rigid substrate 401 of the same size as the rigid substrate 301 shown in FIGS. 3A and 3B. Thus, it is possible to prevent an increase of the area of the rigid substrate 401.

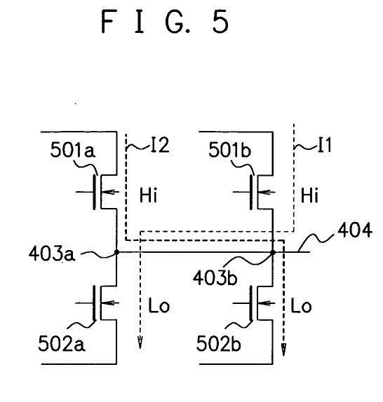

FIG. 5 shows a circuit diagram illustrating exemplary configurations of the scanning ICs 402a, 402b. Hereinafter, a MOS field effect transistor is simply referred to as a transistor. The scanning IC 402a includes N-channel transistors 501a, 502a and the output terminal 403a. The scanning IC 402b includes N-channel transistors 501b, 502b and the output terminal 403b.

As to the transistor 501a, the drain is connected to the high level, and the source is connected to the output terminal 403a. As to the transistor 502a, the drain is connected to the output terminal 403a, and the source is connected to the low level. As to the transistor 501b, the drain is connected to the high level, and the source is connected to the output terminal 403b. As to the transistor 502b, the drain is connected to the output terminal 403b, and the source is connected to the low level. The output lines 404 are connected to the output terminals 403a, 403b.

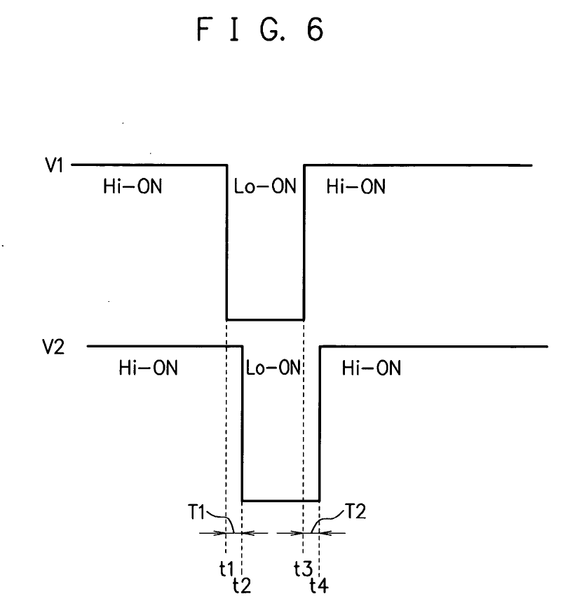

FIG. 6 shows a diagram illustrating the waveforms of a voltage V1 of the output terminal 403a of the scanning IC 402a and a voltage V2 of the output terminal 403b of the scanning IC 402b. The voltages V1, V2 include negative scan pulses. Theoretically, the timing of the scan pulses of the voltages V1, V2 is to be identical. However, a difference in the propagation delay time of the scan pulses is produced due to the dispersion between the scanning ICs 402a, 402b and/or the difference in the temperature between the scanning ICs 402a, 402b. For the above reason, there may be cases that a timing deviation between the scan pulses is produced. Caused by the above deviation, the scan pulse timing of the voltages V1 and V2 may be deviated. Here, when a single scanning IC 302 shown in FIGS. 3A and 3B is used, such the timing deviation of the scan pulses is hard to occur.

In the following, description is given taking an exemplary case that the scan pulse of the voltage V2 lags behind the scan pulse of the voltage V1. Before a time t1, because the transistor 501a is ON and the transistor 502a is OFF, the voltage V1 is set at the high level. Also, because the transistor 501b is ON and the transistor 502b is OFF, the voltage V2 is set at the high level. Next, at the time t1, because the transistor 501a becomes OFF, and the transistor 502a becomes ON, the voltage V1 is turned to the low level. Next, at a time t2, because the transistor 501b becomes OFF, and the transistor 502b becomes ON, the voltage V2 is turned to the low level. Next, at a time t3, because the transistor 502a becomes OFF, and the transistor 501a becomes ON, the voltage V1 is turned to the high level. Next, at a time t4, because the transistor 502b becomes OFF, and the transistor 501b becomes ON, the voltage V2 is turned to the high level.

A penetration period T1 is a period of the time t1 to t2. In the penetration period T1, the voltage V1 is set at the low level, and the voltage V2 is set at the high level, and therefore, a large penetration current I1 undesirably flows in the transistors 501b, 502a. Also, a penetration period T2 is a period of the time t3 to t4. In the penetration period T2, the voltage V1 is set at the high level, and the voltage V2 is set at the low level, and therefore, a large penetration current I2 undesirably flows in the transistors 501a, 502b. When the penetration current flows, the transistors may be broken, or wasteful power may be consumed, which are problems. According to the present embodiment, there is provided a penetration current prevention circuit for preventing the penetration current flowing between the output terminal 403a of the scanning IC 402a and the output terminal 403b of the scanning IC 402b.

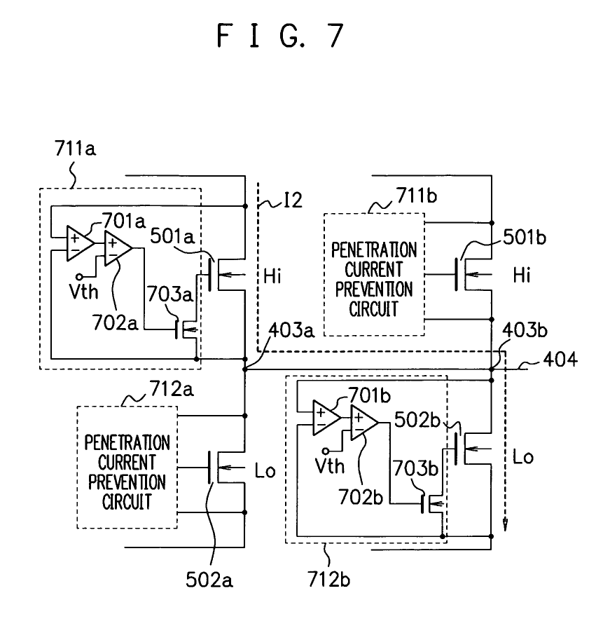

FIG. 7 shows a circuit diagram illustrating the scanning ICs 402a, 402b having penetration current prevention circuits 711a, 711b, 712a, and 712b according to the present embodiment. As for the transistors 501a, 502a, 501b and 502b, and the output terminals 403a, 403b and the output line 404 are identical to the description of FIG. 5.

First, the penetration current prevention circuit 711a in the scanning IC 402a will be explained. In a difference detector 701a, a non-inverse input terminal is connected to the drain of the transistor 501a, and the inverse input terminal is connected to the source of the transistor 501a, and thereby the voltage between the source and the drain of the transistor 501a is output. The voltage between the source and the drain of the transistor 501a is high when the penetration current I2 flows between the source and the drain thereof, while the above voltage is low when the penetration current I2 does not flow. A comparator 702a outputs the high level when the output voltage of the difference detector 701a is a predetermined voltage Vth or higher, while the comparator 702a outputs the low level when the above output voltage is lower than the predetermined voltage Vth. The above predetermined voltage Vth is, for example, a threshold voltage of each transistor. As to an N-channel transistor 703a, the gate is connected to the output terminal of the comparator 702a, the source is connected to the source of the transistor 501a, and the drain is connected to the gate of the transistor 501a.

When the penetration current I2 flows in the period T2, the voltage between the source and the drain of the transistor 501a becomes the predetermined voltage Vth or higher, and the comparator 702a outputs the high level. Then, the transistor 703a is turned ON, and the transistor 501a is turned OFF. As a result, the transistors 501a and 502a are turned OFF, and thereby the output terminal 403a of the scanning IC 402a falls into a high-impedance state (open state), and the penetration current I2 does not flow.

To the contrary, after the time t4, since the penetration current I2 does not flow, the voltage between the source and the drain of the transistor 501a becomes lower than the predetermined voltage Vth, and the comparator 702a outputs the low level. Then, the transistor 703a is turned OFF, while the transistor 501a is held ON. Namely, it is signified that the function of the penetration current prevention circuit is OFF.

Next, the penetration current prevention circuit 712b in the scanning IC 402b will be described. In a difference detector 701b, a non-inverse input terminal is connected to the drain of the transistor 502b, and an inverse input terminal is connected to the source of the transistor 502b, thus outputting the voltage between the source and the drain of the transistor 502b. The voltage between the source and the drain of the transistor 502b becomes high when the penetration current I2 flows between the source and the drain thereof, while the above voltage becomes low when the penetration current I2 does not flow. The comparator 702b outputs the high level when the output voltage of the difference detector 701b is the predetermined voltage Vth or higher, while the comparator 702b outputs the low level when the above output voltage is lower than the predetermined voltage Vth. The predetermined voltage Vth is, for example, a threshold voltage of each transistor. As to the N-channel transistor 703b, the gate is connected to the output terminal of the comparator 702b, the source is connected to the source of the transistor 502b, and the drain is connected to the gate of the transistor 502b.

When the penetration current I2 flows in the period T2, the voltage between the source and the drain of the transistor 502b becomes the predetermined voltage Vth or higher, and the comparator 702b outputs the high level. Then, the transistor 703b is turned ON, and the transistor 502b is turned OFF. As a result, the transistors 501b and 502b are turned OFF, and thereby the output terminal 403b of the scanning IC 402b falls into a high-impedance state (open state), and the penetration current I2 does not flow.

To the contrary, after the time t4, since the penetration current I2 does not flow, the voltage between the source and the drain of the transistor 502b becomes lower than the predetermined voltage Vth, and the comparator 702b outputs the low level. Then, the transistor 703b is turned OFF, while the transistor 502b is held ON. Namely, it is signified that the function of the penetration current prevention circuit is OFF.

Both the above penetration current prevention circuit 711a and the penetration current prevention circuit 712b are not necessarily provided. The penetration current I2 can be prevented even when only providing either one thereof.

Also, the penetration current prevention circuit 712a is provided in the scanning IC 402a, and connected to the transistor 502a. The penetration current prevention circuit 712a has the identical configuration to the penetration current prevention circuit 711b, and thereby the penetration current I1 can be prevented.

Also, the penetration current prevention circuit 711b is provided in the scanning IC 402b, and connected to the transistor 501b. The penetration current prevention circuit 711b has the identical configuration to the penetration current prevention circuit 711a, and thereby the penetration current I1 can be prevented.

Both the above penetration current prevention circuit 712a and the penetration current prevention circuit 711b are not necessarily provided. The penetration current I1 can be prevented even when either one thereof is provided.

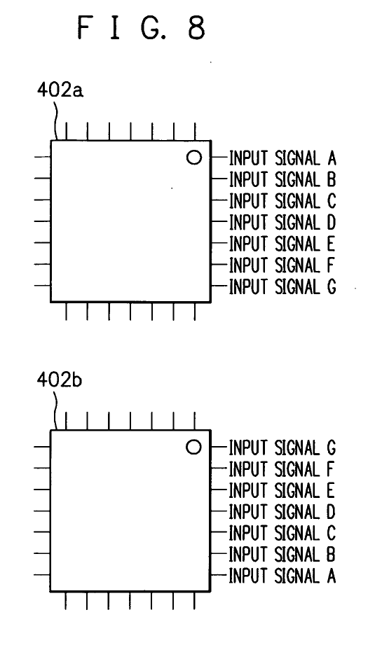

FIG. 8 shows plan views illustrating pin (terminal) layouts of the scanning ICs 402a, 402b. The pin layouts of the scanning IC 402a and 402b are mutually axisymmetric. With this, as shown in FIG. 4B, when the scanning ICs 402a, 402b are connected via the rigid substrate 401, the connection becomes easy because the pin layouts are mutually the same.

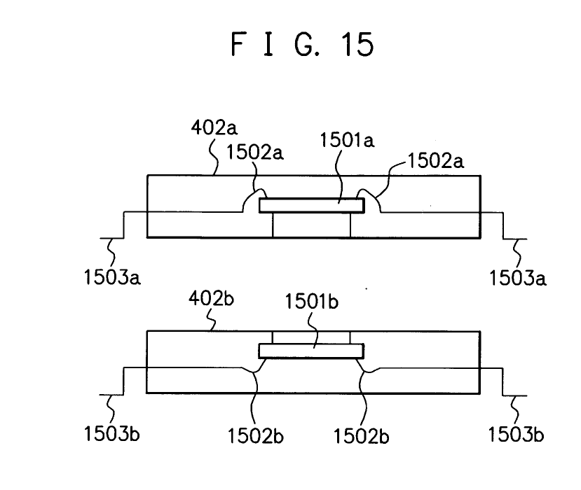

FIG. 15 shows cross-sectional views illustrating exemplary configurations of the scanning ICs 402a, 402b shown in FIG. 8. In the scanning IC 402a, a semiconductor chip 1501a is connected to pins (terminals) 1503a by bonding wires 1502a. In the scanning IC 402b, a semiconductor chip 1501b is connected to pins (terminals) 1503b by bonding wires 1502b. The semiconductor chips 1501a, 1501b have an identical configuration, and are connected to pins (terminals) 1503a, 1503b with the front and back sides mutually reversed. With this, as shown in FIG. 8, the pin layouts of the scanning ICs 402a, 402b become mutually axisymmetric.

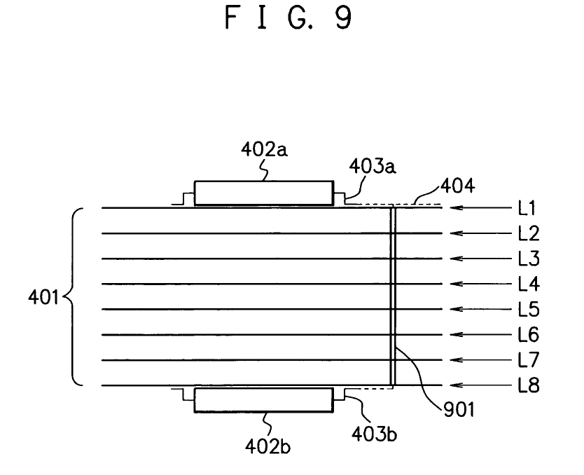

FIG. 9 shows a cross-sectional view illustrating an exemplary configuration of the rigid substrate 401. The rigid substrate 401 includes eight layers L1-L8. The first layer L1 is a component layer. The second layer L2 is a shield layer. The third layer L3 is a ground plane (layer). The fourth layer L4 is a power supply layer. The fifth layer L5 is a power supply layer. The sixth layer L6 is a ground plane (layer). The seventh layer L7 is a shield layer. The eighth layer L8 is a solder plane. The first layer L1 is the front surface of the rigid substrate 401, while the eighth layer L8 is the back surface of the rigid substrate 401. The second layer L2 is the first layer inside the front surface L1. The third layer L3 is the second layer inside the front surface L1. The fourth layer L4 is the third layer inside the front surface L1. The seventh layer L7 is the first layer inside the back surface L8. The sixth layer L6 is the second layer inside the back surface L8. The fifth layer L5 is the third layer inside the back surface L8. The scanning IC 402a is mounted on the first layer L1, while the scanning IC 402b is mounted on the eighth layer L8. The output terminals 403a of the scanning IC 402a and the output terminals 403b of the scanning IC 402b are mutually short-circuited via a via hole portion 901 of the rigid substrate 401, and connected to the output line 404.

As described above, according to the present embodiment, the number of scan pulse output terminals 403a, 403b can be increased by mounting the scanning ICs 402a, 402b respectively on both surfaces of the rigid substrate 401. This can realize a high definition plasma display device having a number of Y-electrodes Y1.

### Second Embodiment

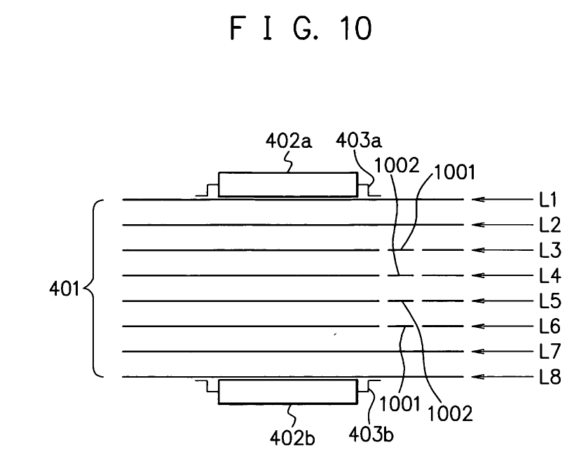

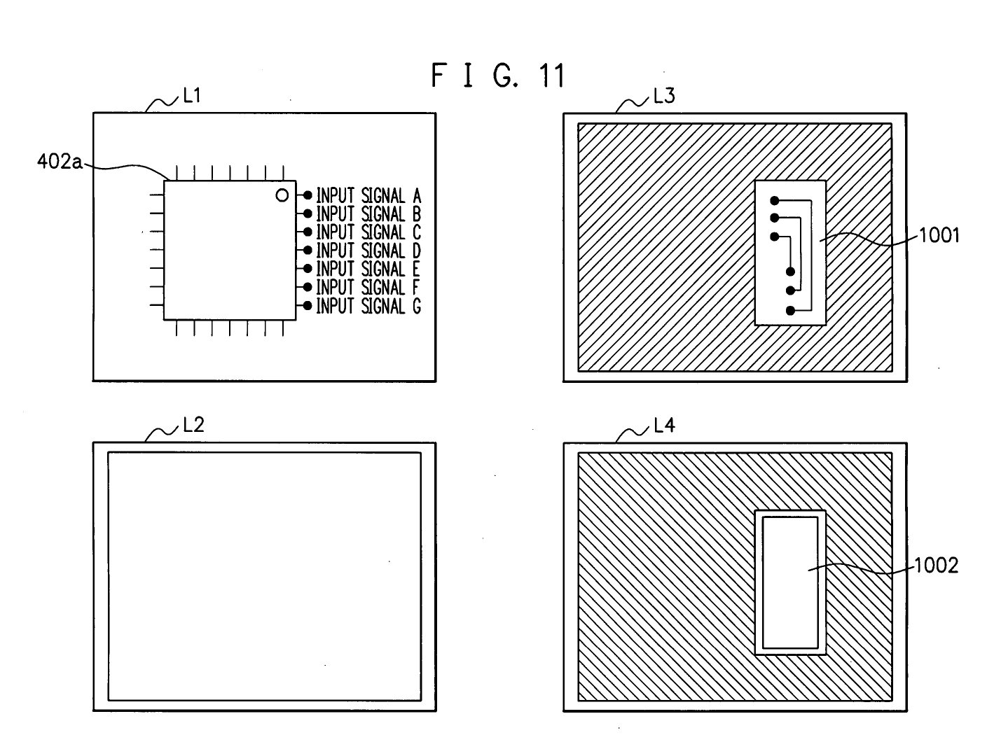

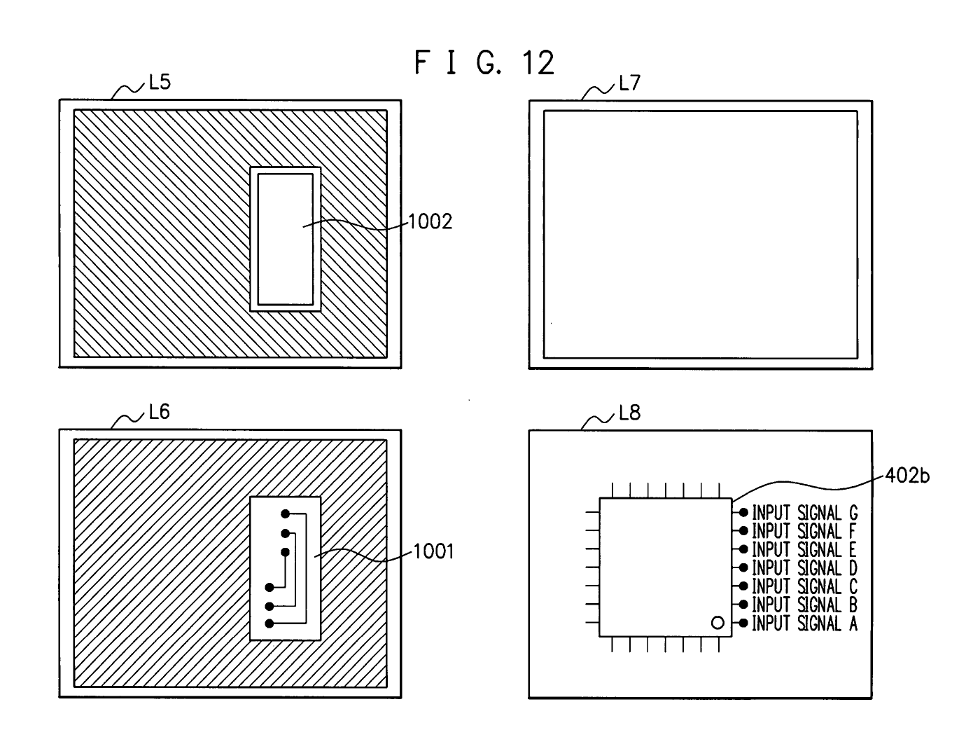

FIG. 10 shows a cross-sectional view illustrating an exemplary configuration of a rigid substrate 401 according to a second embodiment of the present invention. FIG. 11 shows plan views of a first layer L1 to a fourth layer L4 of the rigid substrate 401, and FIG. 12 shows plan views of a fifth layer L5 to an eighth layer L8 of the rigid substrate 401. In the first embodiment, the case that the pin layouts of the scanning ICs 402a, 402b are axisymmetric has been described, as shown in FIG. 8. Hereinafter, the different points of the present embodiment from the first embodiment will be described. According to the present embodiment, an exemplary configuration of the rigid substrate 401 when the scanning ICs 402a, 402b have an identical configuration is shown. Namely, the pin layouts of the scanning ICs 402a, 402b are identical. In other words, when mounting the scanning ICs 402a, 402b on both surfaces of the rigid substrate 401, the pin layouts of the scanning ICs 402a, 402b become mutually opposite. Therefore, in order to connect the corresponding output terminals 403a, 403b of the scanning ICs 402a, 402b via the rigid substrate 401, switch-over connection portions 1001 are necessary. The switch-over portions 1001 are provided on the third layer (ground layer) L3 and the sixth layer (ground layer) L6. In order to shield the above switch-over portions 1001, shields 1002 are provided on the fourth layer (power supply layer) L4 and the fifth layer (power supply layer) L5 corresponding to the switch-over portions 1001. The shields 1002 are grounded. With this, the entire other layers L2, L4, L5 and L7 than the portions corresponding to the switch-over portions 1001 are shielded thoroughly by the ground, and thereby noise can be prevented.

### Third Embodiment

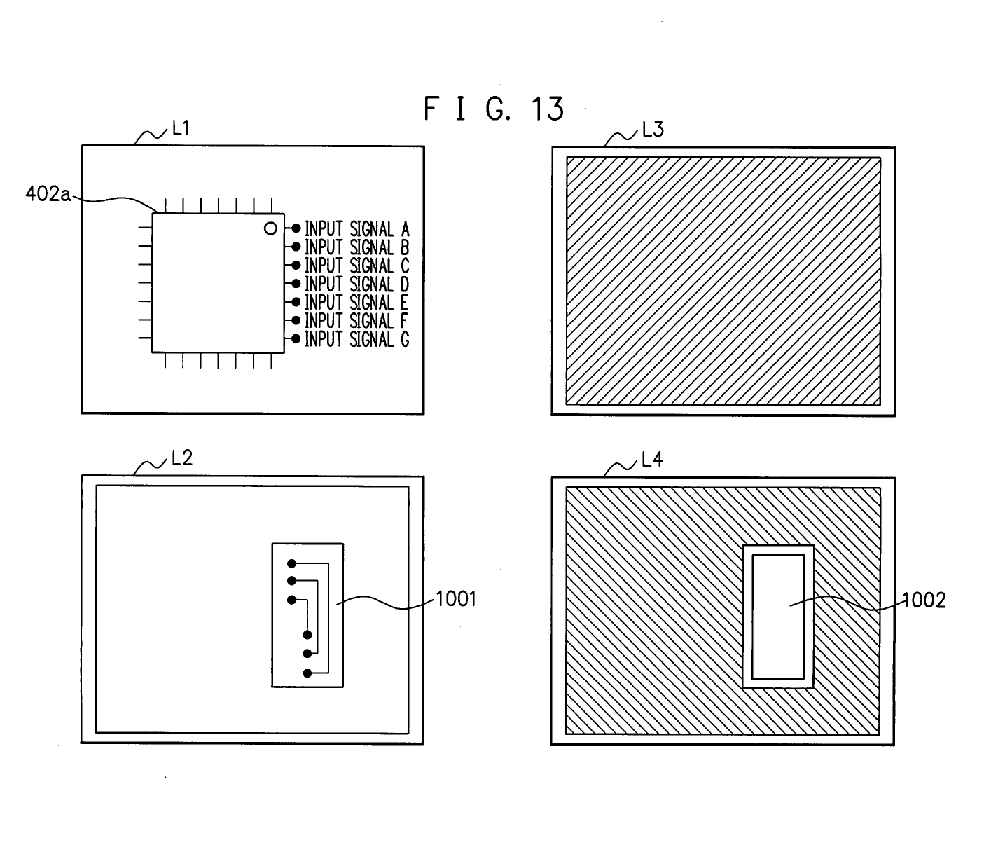

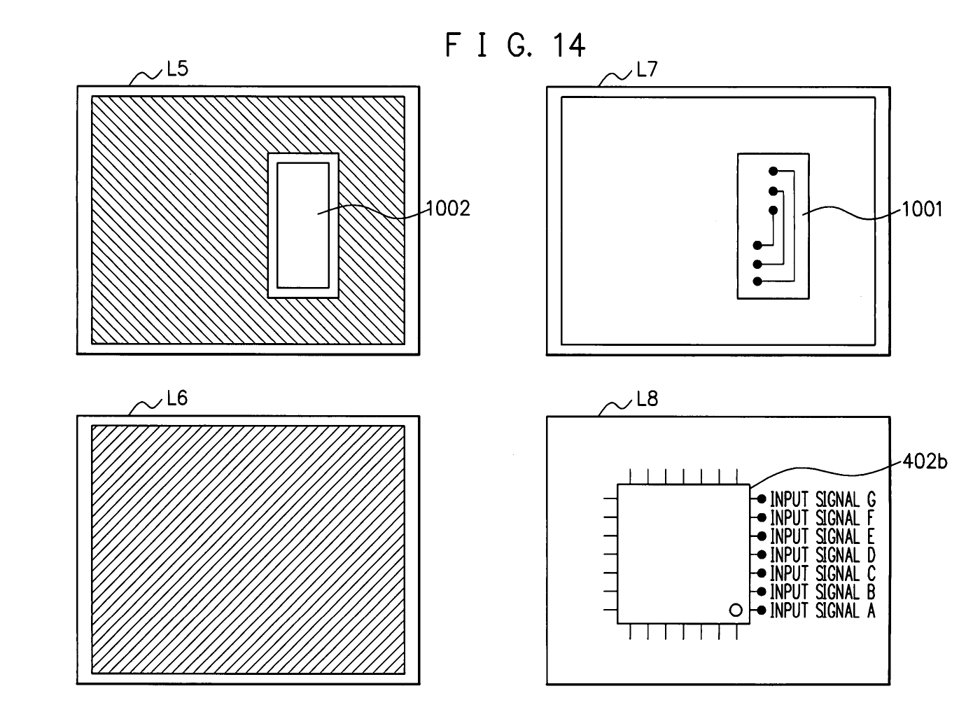

FIG. 13 shows the plan views of a first layer L1 to a fourth layer L4 of a rigid substrate 401 according to a third embodiment of the present invention, and FIG. 14 shows the plan views of a fifth layer L5 to an eighth layer L8 of the rigid substrate 401. The different points of the present embodiment from the second embodiment will be described. Switch-over portions 1001 are provided in the second layer (shield layer) L2 and the seventh layer (shield layer) L7. In order to shield the above switch-over portions 1001, shields 1002 are provided on the fourth layer (power supply layer) L4 and the fifth layer (power supply layer) L5 corresponding to the above switch-over portions 1001. The shields 1002 are grounded. With this, the entire other layers L3, L4, L5 and L6 than the portions corresponding to the switch-over portions 1001 are shielded thoroughly by the ground, and thereby noise can be prevented.

As having been described above, according to the first to the third embodiments, the scanning ICs 402a, 402b are mounted respectively on both surfaces of the rigid substrate 401, the output terminals 403a, 403b of the scanning ICs 402a, 402b are short-circuited, and further the penetration current prevention circuit is provided to prevent penetration current between the scanning ICs 402a, 402b. The penetration current prevention circuit detects the penetration current between the scanning ICs 402a, 402b, and by turning OFF the output transistor of the scanning IC 402a or 402b, the penetration current can be prevented. As a method for detecting the penetration current, for example, the detection of a voltage or a penetration current between the source and the drain of the output transistor of the scanning IC 402a or 402b is performed.

With this, even when the scanning ICs 402a, 402b are mounted respectively on both surfaces of the rigid substrate 401 and the output terminals 403a, 403b are short-circuited, it is possible to prevent the penetration current between the scanning ICs 402a, 402b. Also, by short-circuiting the output terminals 403a, 403b, and by selecting either the double-sided mounting (FIGS. 4A and 4B) or the single-sided mounting (FIGS. 3A and 3B) of the rigid substrate 401 in plasma display devices of different inch sizes, it is possible to cope with the plasma display devices from small to large sizes. Thus, the rigid substrate 401 can be used in common.

It is to be noted that, in the aforementioned embodiments, typical examples for embodying the present invention have merely been described, and it is not to be understood the technical scope of the present invention restrictively. In other words, the present invention may be implemented in various forms without deviating from the technical idea or the major features of the present invention.

The number of scan pulse output terminals can be increased by mounting first and second scanning ICs on both surfaces of a circuit substrate. This can realize a high definition plasma display device having a number of Y-electrodes.

What is claimed is:

1. A plasma display device comprising:
first and second substrates;
a plurality of X-electrodes provided on said first substrate;
a plurality of Y-electrodes provided on said first substrate so as to be disposed in parallel with said plurality of X-electrodes, for generating sustain discharge between said plurality of X-electrodes and said plurality of Y-electrodes;
a plurality of address electrodes provided on said second substrate so as to intersect with said X-electrodes and said Y-electrodes, for generating address discharge between said Y-electrodes and said address electrodes;
an X-electrode drive circuit applying voltage for said sustain discharge to said plurality of X-electrodes;
a Y-electrode drive circuit applying voltage for said sustain discharge to said plurality of Y-electrodes;
an address electrode drive circuit applying voltage for said address discharge to said plurality of address electrodes; and
a scanning circuit successively applying scan pulses for said address discharge to said plurality of Y-electrodes,
wherein said scanning circuit is constituted of first and second scanning integrated circuits (IC), and said first and second scanning ICs are mounted on both surfaces of a circuit substrate, respectively.

2. The plasma display device according to claim 1, wherein output terminals of said first and second scanning ICs are short-circuited.

3. The plasma display device according to claim 2, further comprising:
a penetration current prevention circuit preventing penetration current from flowing between the output terminals of said first and second scanning ICs.

4. The plasma display device according to claim 3, wherein, when the penetration current flows between the output terminals of said first and second scanning ICs, said penetration current prevention circuit sets the output terminal of said first scanning IC to a high impedance state.

5. The plasma display device according to claim 3, wherein said penetration current prevention circuit comprises first and second penetration current prevention circuits,
when the penetration current flows between the output terminals of said first and second scanning ICs, said first penetration current prevention circuit sets the output terminal of said first scanning IC to a high impedance state, and when the penetration current flows between the output terminals of said first and second scanning ICs, said second penetration current prevention circuit sets the output terminal of said second scanning IC to a high impedance state.

6. The plasma display device according to claim 5, wherein said first penetration current prevention circuit is provided in said first scanning IC, and said second penetration current prevention circuit is provided in said second scanning IC.

7. The plasma display device according to claim 1, wherein the terminal layouts of said first and second scanning ICs are mutually axisymmetric.

8. The plasma display device according to claim 2, wherein said circuit substrate comprises shield layers as the first layer inside the front surface and the first layer inside the back surface.

9. The plasma display device according to claim 2, wherein said first and second scanning ICs have an identical configuration, and
wherein said circuit substrate performs switch-over connection of the output terminals of said first and second scanning ICs in both the first layer inside the front surface and the first layer inside the back surface.

10. The plasma display device according to claim 2, wherein said first and second scanning ICs have an identical configuration, and
said circuit substrate performs switch-over connection of the output terminals of said first and second scanning ICs in both the second layer inside the front surface and the second layer inside the back surface, and said switch-over connection portion is shielded by the entire other layers.

11. The plasma display device according to claim 4, wherein said first scanning IC comprises a first field effect transistor for connecting the high level to said output terminal and a second field effect transistor for connecting the low level to said output terminal, and
wherein said penetration current prevention circuit sets the output terminal of said first scanning IC to a high impedance state by turning off said first and second field effect transistors.

12. The plasma display device according to claim 11, wherein, when the voltage between the source and drain of said first field effect transistor becomes a predetermined value or higher, said penetration current prevention circuit turns off said first field effect transistor.

13. The plasma display device according to claim 12, wherein said predetermined value is the threshold voltage of the field effect transistor.

14. The plasma display device according to claim 11, wherein, when the voltage between the source and drain of said second field effect transistor becomes a predetermined value or higher, said penetration current prevention circuit turns off said second field effect transistor.

15. The plasma display device according to claim 14, wherein said predetermined value is the threshold voltage of the field effect transistor.

16. The plasma display device according to claim 11, wherein, when the voltage between the source and drain of said first field effect transistor becomes a predetermined value or higher, said penetration current prevention circuit turns off said first field effect transistor, and when the voltage between the source and drain of said second field effect transistor becomes a predetermined value or higher, said penetration current prevention circuit turns off said second field effect transistor.

17. The plasma display device according to claim 16, wherein said predetermined values are the threshold voltages of the field effect transistors.

18. The plasma display device according to claim 2, wherein said circuit substrate comprises a shield layer, a ground layer and a power supply layer.

19. The plasma display device according to claim 18, wherein said circuit substrate comprises a first shield layer, a first ground layer, a first power supply layer, a second power supply layer, a second ground layer, and a second shield layer in that order.

20. The plasma display device according to claim 7, wherein said first scanning IC comprises a first semiconductor chip connected to terminals by bonding wires, and said second scanning IC comprises a second semiconductor chip connected to terminals by bonding wires, and
wherein said first and second semiconductor chips have an identical configuration, which are connected to said terminals with the front and back sides mutually reversed.
